(19) United States
(12) Patent Application Publication
(10) Pub. No.: US 2004/0110013 A1
(43) Pub. Date: Jun. 10, 2004

(54) Method of increasing mechanical properties of semiconductor substrates

(76) Inventors: Karl J. Yoder, Denison, TX (US); Bradley D. Sucher, McKinney, TX (US)

Correspondence Address: TEXAS INSTRUMENTS INCORPORATED, P O BOX 655474, M/S 3999, DALLAS, TX, 75265

(21) Appl. No.: 10/703,803

(22) Filed: Nov. 7, 2003

Related U.S. Application Data
(63) Continuation-in-part of application No. 10/206,005, filed on Jul. 26, 2002, now abandoned.

(51) Int. Cl. B32B 9/04

(52) U.S. Cl. 428/446

(57) ABSTRACT

Semiconductor wafers exhibiting increased mechanical strength and reduced susceptibility to fracture and methods of making the same are disclosed. The improved mechanical strength arises from a thin coating of a refractory material deposited on the backside of the wafer. Preferably, the coating is comprised of a ceramic. More preferably, the coating is comprised of silicon carbide. Also disclosed are methods for evaluating different coating materials.

This application is a continuation-in-part of application Ser. No. 10/206,005 filed Jul. 26, 2002.

### CROSS-REFERENCE TO RELATED APPLICATIONS

Not applicable.

### BACKGROUND OF THE INVENTION

1. Field of the Invention

The present invention generally relates to semiconductor processing. More particularly, the invention relates to techniques for improving mechanical properties of semiconductor wafers.

2. Background Information

The ubiquitous presence of semiconductors in almost every electronic device is testament to their importance in today's society. Semiconductor manufacturing undergoes a reduction in the overall feature size of the integrated devices approximately every 18 months and the size of the semiconductor substrate has increased to the current 300 mm in diameter. This continuous effort results in reducing the cost of manufacturing semiconductor integrated devices, as well as increasing the potential functionality that each semiconductor integrated device is able to provide because more integrated devices may now be built in the same substrate area and even more devices can be manufactured in the increasingly large substrate.

Semiconductor integrated devices are built vertically with respect to a substrate, called a “wafer,” in a similar fashion a house is built upon a foundation. The building of semiconductor devices on a wafer involves a series of processing steps (e.g., oxidation, epitaxy, implant, photolithography, deposition, multiprobe, etc.). This processing is done in very costly semiconductor fabrication facilities, called “fabs,” where each step required to manufacture the semiconductor integrated device involves complex and expensive equipment. Hence, semiconductor companies have a great incentive in capitalizing the cost of this equipment by running the fabs continuously, and also by maximizing yield, which can be measured as the total number of functional semiconductor devices with respect to the total number wafers ran through the fab.

While the overall yield of a fab may be affected by many factors, the physical handling of wafers at various processing steps by both machines and humans presents mechanical stresses that sometimes cause the wafers to fracture, thereby decreasing the overall yield. This problem is only worsened by the fact that the wafers are cut from a single ingot into very thin slices (e.g., 400 μm to 1000 μm in thickness), which makes them easier to fracture. In addition, the ingot and subsequent wafers are purposefully composed of crystalline structures; all of this results in wafers that are very brittle.

The wafers could be sliced from the ingot in thicker slices so that they are less apt to break under mechanical stress. However, their crystalline nature would still render them brittle, and making the wafers thicker would have the negative effect of driving up their cost. There are a number of techniques that attempt to address the problem of fracturing the wafers. For example, U.S. Pat. No. 5,110,764 to Ogino discloses beveling the edges of the wafer to reduce the risk of chipping the edges of the wafer. However, beveling the edges of the wafer is only helpful in reducing chipping and other mechanical stress at the edge of the wafer, and as such, mechanical stress imposed on the front side where most of the semiconductor devices and the wiring that connects the individual devices are located or the back side of the wafer, which provides mechanical support to the integrated devices, may still fracture the wafer. In addition, established material strengthening schemes that are beneficial to metallic and ceramic materials do not apply to semiconductor wafers because such schemes involve structural modification, and any modification of the wafer's crystalline structure would affect the operation of the electrical devices (i.e., transistors, diodes, resistors, etc.) integrated thereupon. Accordingly, a need exists for increasing mechanical strength of semiconductor wafers.

### BRIEF SUMMARY OF THE PREFERRED EMBODIMENTS OF THE INVENTION

The problems noted above are addressed by coating the back side of the wafer with a film or coating at the proper occasion during the lengthy process of manufacturing a integrated circuit. The coating is preferably a material that is compatible to semiconductor wafer processing, it is also desirable for the coating material to be able to withstand high temperatures (e.g., 1000° C.). For example, the coating may be a ceramic coating such as silicon carbide. In an alternate embodiment, the coating may be silicon dioxide. In yet another embodiment, the coating may be silicon nitride. In addition, the coating may be removed prior to dicing the wafer into separate integrated circuits.

### BRIEF DESCRIPTION OF THE DRAWINGS

For a detailed description of the preferred embodiments of the invention, reference will now be made to the accompanying drawings, wherein like parts throughout the drawings are marked with the same reference numerals:

FIG. 1 depicts the formation of the ingot;

FIG. 2A depicts the ingot separated into wafers;

FIG. 2B depicts the front side and back side of a wafer;

FIG. 3 depicts a schematic representation of a four-point bend test apparatus;

FIG. 4 depicts a wafer with a coating on the back side;

FIG. 5 depicts the measured thickness of exemplary coatings;

FIG. 6 depicts a table of measured film stress;

FIG. 7 depicts modulus of rupture (MOR) data for coated wafers; and

FIG. 8 depicts the percent gain in MOR from the coating.

FIG. 9 depicts a flowchart of the formation of non-crystalline coating on the backside of a wafer.

### NOTATION AND NOMENCLATURE

In the following description and claims, the terms “substrate,” “semiconductor wafer,” and “wafer” are used synonymously, and refer to a disc cut from a semiconductor ingot, where the ingot may comprise any semiconducting element or compound. When a semiconductor wafer is received at a fab ready for forming integrated circuit devices therein, the wafer is referred to as a “starting wafer” even though the wafer has undergo a lengthy process from wafer sawing, lapping, chemical etching, and polishing. The side of a wafer on which integrated circuit devices are formed is referred to as the front side of the wafer or the top surface of the wafer. The opposite side of the wafer on which no integrated circuit device structure is formed is referred to as the back side of the wafer or the bottom surface of the wafer. To the extent that any term is not specially defined in this specification, the intent is that the term is to be given its plain and ordinary meaning.

### DETAILED DESCRIPTION OF THE PREFERRED EMBODIMENTS

Prior to delving into the preferred embodiments of the present invention, it is helpful to give a cursory review of semiconductor wafer manufacturing and processing, and material strengthening and testing techniques. A more detailed presentation of related concepts can be found in “Influence of Design and Coatings on the Mechanical Reliability of Semiconductor Wafers,” by Karl J. Yoder, and “Principles of CMOS VLSI Design,” pp. 109-172, by Neil H. E. West et al.

Semiconductor Wafer Manufacturing and Processing

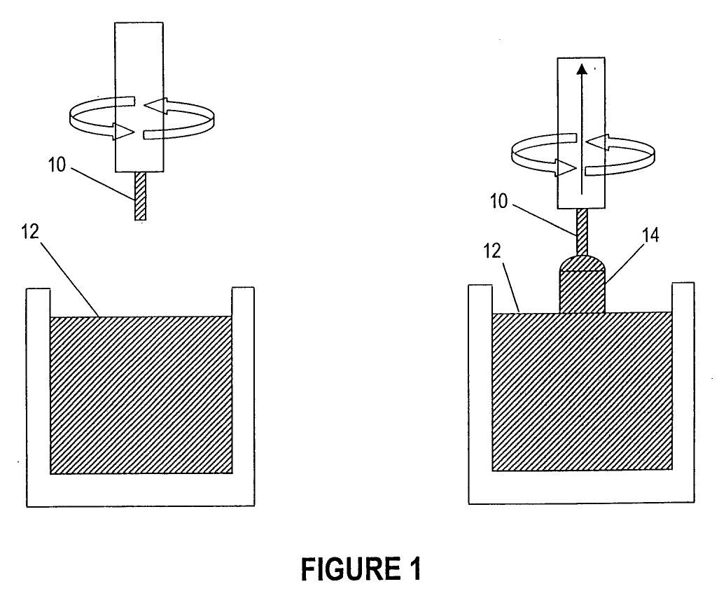

Wafers are derived from a single crystal ingot grown from a melt by a pulling method (Czochralski or Teal-Little) as depicted in FIG. 1. A crystal seed 10 is dipped into a melt 12 while it slowly rotates. Note that the crystal seed 10 and the melt 12 usually comprise the same materials. By controlling the temperature of the melt and the amount of heat removed from the seed the melt freezes onto the seed and the crystal grows. This growth results in a final ingot 14. Seed diameters are typically in the range of a few millimeters and the final ingot diameter may exceed 300 mm. Controlling the diameter of the growing crystal is accomplished by varying the melt temperature, seed crystal rotation rate, and seed pull rate.

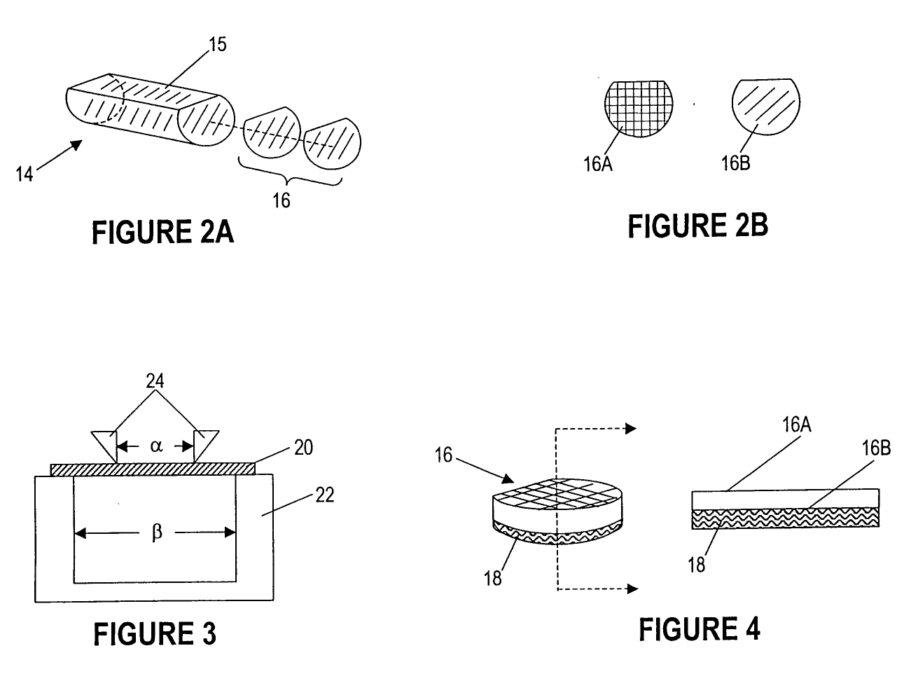

Once the ingot 14 is formed, it is taken through various mechanical shaping operations. FIG. 2A depicts the ingot 14 with a notch 15, and with the ingot 14 sliced into wafers 16. The wafers 16 have a front side 16A where the semiconductor devices are fabricated, and a backside 16B that provides mechanical support as shown in FIG. 2B.

It should be noted that great care is taken in producing the crystalline structure of the wafers because it serves as the basis of operation of semiconductor devices integrated thereon; thus, the crystalline nature of the wafer is deliberate and required.

Once a wafer is delivered to a fab, the integrated circuit manufacturing processing takes the wafer through many process steps, such as: surface cleaning, epitaxial crystal growth, oxidation, ion-implantation, dopant-diffusion, photolithography, etching, film-deposition, probing, and back-grinding.

Various equipment manufacturers supply the equipment used in wafer production, and there is no standard among the equipment in handling of the wafers. As such, a large variety of wafer handling systems exist. Thus, it is important that the wafer be strong to withstand the fabrication process in order support high yield and profitability.

Note that semiconductor ingots may comprise various compounds as would be familiar to one of ordinary skill in the art. Common examples are silicon and gallium arsenide. Although the following discussion centers on silicon wafers, the principles of this invention equally apply to wafers of other compounds (i.e., elements from column IV of the periodic table of elements as well as combinations of elements from columns III-V).

Material Strengthening and Testing

When an external load is applied to a material, the material deforms due to differences in the atomic spacing between the materials. Stress σ is the term used for the external load and is usually given in units of pressure. The subsequent deformation or strain ε is defined as a percent equal to the change in length over the initial length.

The strain a material exhibits depends on a number of factors: atomic bond strength, stress, and temperature. Elastic deformation refers to reversible strain, or the ability of a material to return to its original state when the stress is removed. Equation (1) defines the relationship for tensile stress, where E is Young's modulus.

σ=Eε (1)

For shear loading, Equation (2) defines the stress-strain relationship where τ is the shear stress, γ is the shear strain, and G is the shear modulus.

τ=Gγ (2)

Most ceramics exhibit brittle fracture, where the material behaves elastically with no plastic deformation up to fracture at low temperatures. Additionally, many high purity crystals (e.g., semiconductor substrates) behave in this manner unless there is a suitable method for stress relief, such as purposefully generating dislocations. Otherwise, a crack front will propagate along a crystal plane with relative ease when there is no means to relieve the stress. Stress on a crystalline material may also cause slips in the crystal.

Brittle materials (such as ceramics and semiconductor substrates) are commonly tested using bend strength tests. For bending tests, the sample is supported at each end, and a load is applied at either one central point (three-point bending) or two points (four-point bending). FIG. 3 shows a four-point bending arrangement and will be described in detail below. The bend strength is defined by the modulus of rupture (MOR), or the maximum tensile stress at material failure. Equation (3) gives the bend strength of a rectangular structure where M is the moment, c is the distance from the neutral axis to the tensile surface, and I is the moment of inertia. For a rectangular sample, I=bd³/12 and c=d/2 where d is the thickness of the sample and b is the width.

$$S = \frac{M c}{I} \qquad ( 3 )$$

Referring now to FIG. 4, a semiconductor wafer 16 is shown in accordance with a preferred embodiment of the present invention. The wafer 16 is preferably a silicon wafer coated with a film 18 on the backside 16B of the wafer. The film 18 is preferably ceramic, but other embodiments may include non-ceramic films as well. Several different types of ceramic coatings (e.g., silicon dioxide, silicon nitride, and silicon carbide) having a nominal thickness of about 1 μm were tested.

It should be noted that both wafers and ceramic coatings can be quite brittle and using a brittle ceramic coating to strengthen a brittle wafer may seem contradictory. In order to understand this seemingly contradictory practice, consider traditional mechanical strengthening schemes from non-semiconductor applications. A traditional mechanical strengthening scheme involves mixing additional materials (e.g., whisker-like fibers) into a bulk material. In this manner, the additional material serves to distribute the mechanical stress through the bulk material, and also serves to distribute propagating fractures along the length of the fibers. To further this concept, the whisker-like fibers may be pre-tensioned to give more support and possibly close the fracture. However, traditional mechanical strengthening techniques may not apply to semiconductor wafers because mixing additional material with the crystalline wafer alters the crystalline structure of the wafer and renders it difficult for building semiconductor devices thereon.

On the other hand, coating the backside of the wafer with a pre-stressed ceramic film provides the desirable benefits without compromising the crystalline nature of the wafer. The reason is that although the wafer and the ceramic are both brittle, most ceramic are less brittle than crystalline wafers. Thus, it is possible to select a ceramic film that will enhance the mechanical strength of the wafer so that any force that would normally cause a fracture or slip now must overcome the residual stress of the film. One main concern in selecting a strengthening material is that the material selected must not affect the electrical properties of the wafer in an adverse way. Accordingly, several different ceramic materials that are commonly used in semiconductor processing were tested and are detailed below. Note that the testing described below was not an exhaustive search for all the possible materials, but rather an analysis of materials common to semiconductor processing. One of ordinary skill in the art will recognize that other viable coatings exist that fall within the scope and spirit of this disclosure.

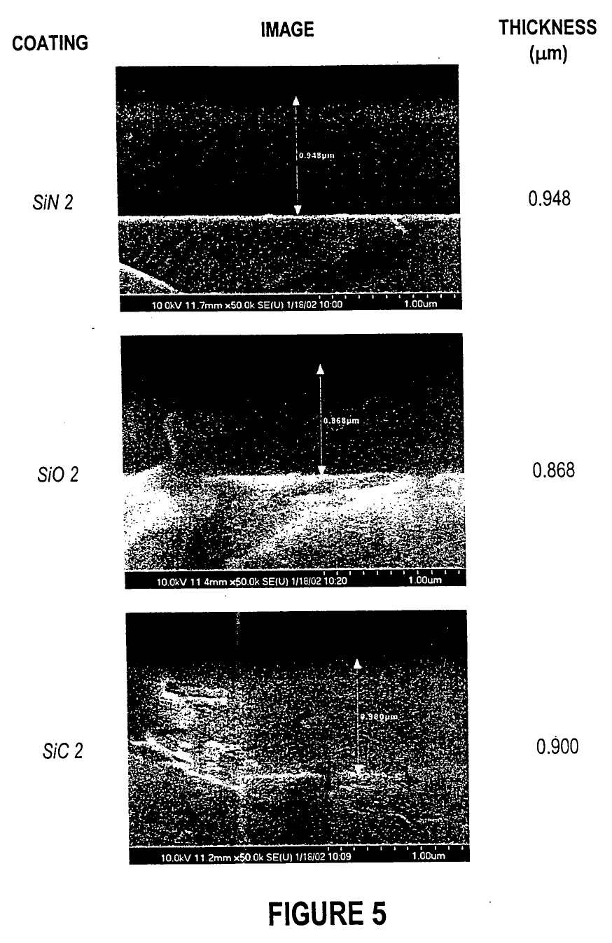

Silicon dioxide (SiO₂) is a material that may be used as a ceramic film. Despite its inherent brittleness, the mechanical strength of SiO₂ may be increased by inducing compressive stress in the surface layer of the material using methods such as thermal tempering as well as other chemical methods. Silicon nitride (Si₃N₄) may also be used as a ceramic film. The methods of producing silicon nitride include nitridation and plasma-enhanced chemical vapor deposition (PECVD). Nitridation involves a high temperature reaction between nitrogen species and the silicon surface. PECVD nitride is formed through the relatively low temperature reaction of silane based compounds with suitable hydrocarbons while in the presence of a RF field. Schemes of depositing silicon dioxide and silicon nitride may be found in “Plasma-Deposited Passivation Layers for Moisture and Water Protection,” Surface and Coatings Technology, vol. 74-75 (1995), pp. 676-681. In addition, silicon carbide (SiC) may be used as a thin film ceramic. The SiC film may be produced by a PECVD reaction of silane based compounds with suitable hydrocarbons. A method of depositing SiC is outlined in “PECVD Silicon Carbide as a Chemically Resistant Material for Micromachined Transducers,” Sensors and Actuators, vol. A 70(1998), pp. 48-55. FIG. 5 depicts one group of SiC films measured using a Hitachi S-4700 scanning electron microscope, with the film thickness ranging between 0.85 μm and 0.95 μm. It should be noted that while the range of thickness among the tested samples is between 0.85 μm and 0.951 μm, a preferred range is from 0.5 μm to 4 μm.

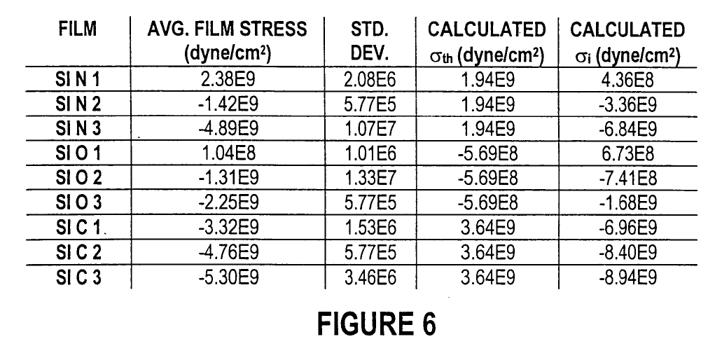

The strength of the wafers coated with ceramic film was tested using a four-point test rig as shown in FIG. 3. Referring now to FIG. 3, a sample wafer 20 is shown supported by a stand 22, with a two-point stylus 24 applying a downward force. The distance between the two edges of the stand 22 is β and the distance between the two points of the stylus 24 is α. Samples of each ceramic film type were tested using the four-point test rig arrangement of FIG. 3, with β equal to 10 cm and α equal to 5 cm. The residual stress σᵣ of each coating was measured using an SMSi 9000WM stress measurement system. The instrument determines the bow in the wafer before and after it is coated with the ceramic film using the Stoney's equation:

$${σ}_{r} = \frac{{Et}_{s}^{2}}{6 ( 1 - v ) t} ( \frac{1}{{R}_{f}} - \frac{1}{{R}_{o}} ) \qquad ( 4 )$$

where E is the Young's modulus of the substrate, v is Poisson's ratio of the substrate, tₛ is the thickness of the substrate, t is the thickness of the film, and Rₒ and R_{f} are the initial and final radii of curvature of the wafer respectively, before and after it is coated with the ceramic film. FIG. 6 shows the measured residual film stress σᵣ of three samples of each wafer type.

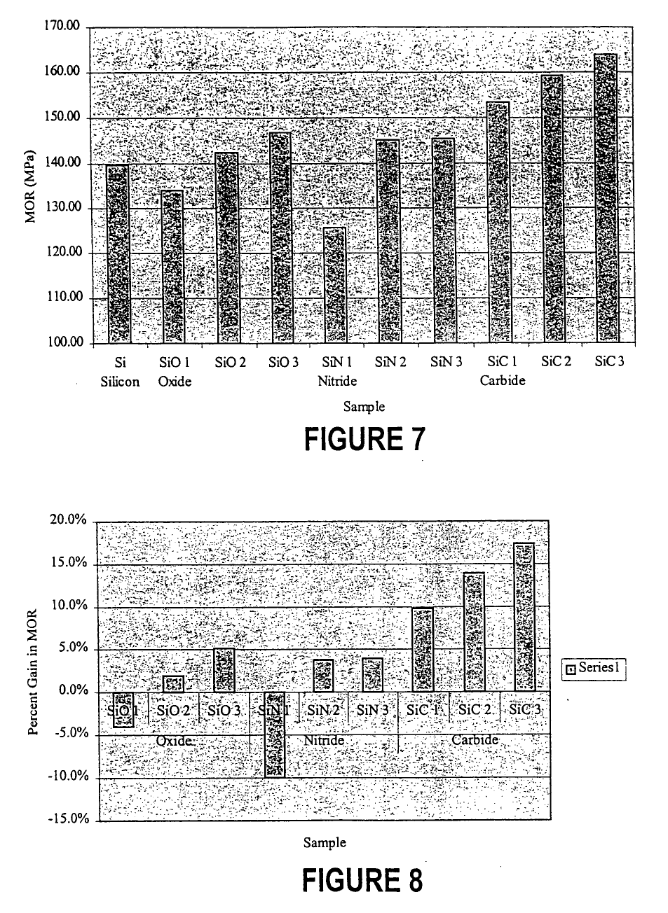

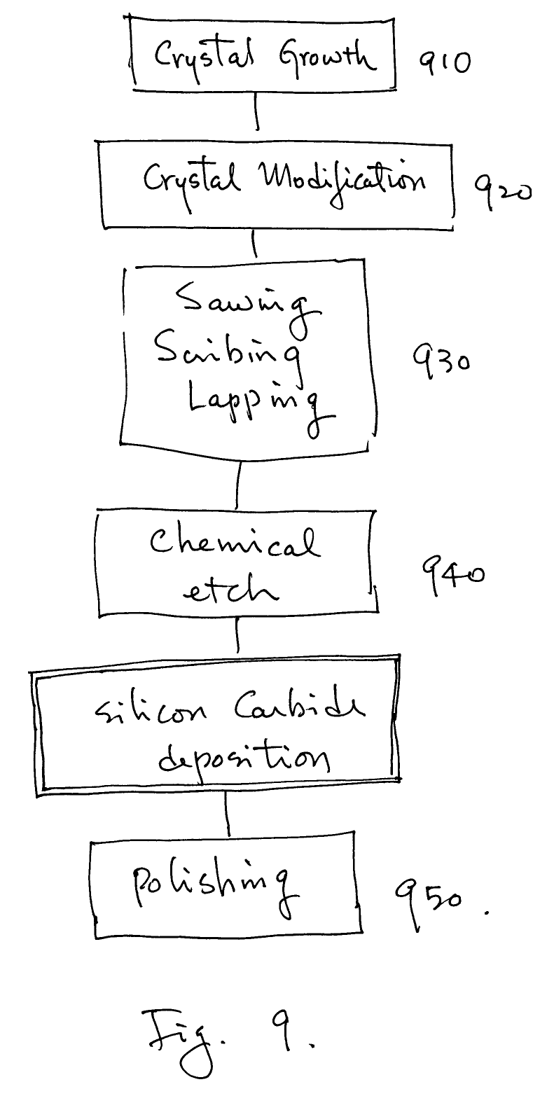

The four-point bending test results of the coated and non-coated samples are shown in FIG. 7. For each of the tested sample types, the MOR was calculated. Referring to FIG. 7, it can be shown that the bare silicon wafer had an average MOR of 139.69 MPa; the SiN-coated samples had an average MOR of 125.7, 144.9, and 145.2 MPa, respectively; the SiO-coated samples had an average MOR of 134.0, 142.4, and 146.8 MPa, respectively; and the SiC-coated samples had an average MOR of 153.4, 159.2, and 164.0 MPa, respectively. FIG. 8 shows the overall gain in the MOR achieved by coating the wafers, which, in the case of SiC measured as high as 17%. Thus, from FIGS. 6, 7, and 8 it can be seen that the overall mechanical strength of the ceramic coated silicon wafer is greater than the non-coated wafer. It should be noted that of the three compounds discussed above, SiC is the most preferred because it is more resistant to the chemicals used in semiconductor processing and it therefore less likely to be etched away by chemicals used in the various processing steps (e.g., hydrofluoric acid) and yields the greatest increases in mechanical strength. Also, one of ordinary skill in the art having the benefit of this disclosure would recognize that the desired coating need not be absolutely immune from all possible etching and still achieve the desired effect. For example, if a silicon carbide layer that is deposited on the backside of the wafer is originally 3 μm thick, and were 70% of its original thickness (2.1 μm) prior to dicing the wafer, this would still provide adequate strengthening.

Good adhesion of coating to the semiconductor wafer is important. Scaling or flaking of the coating is unacceptable since the flaking particles could contaminate the front side of the wafers that are being processed, thereby reducing yield. Adhesion of the desired material is preferably greater than b 100 J/m². Once the wafer is completely processed, the coating may be removed in the back-grind step prior to dicing the wafer.

The coating of the back side of a wafer may take place at any appropriate point during the manufacturing of the integrated circuit device. In particular, it is preferred to coat the wafer at the earliest occasion so the mechanical strength of the wafer is enhanced to prevent wafer breakage and crystal slippage. One example of early coating is during the wafer manufacturing prior to shipping the starting wafers to the fabs. A flowchart of such a process is depicted in FIG. 9.

The process depicted in FIG. 9 starts with crystal growth process 910. The process is described in a previous section. Following the crystal growth, the ingot is modified in the crystal modification step 920. In this step, the ingot is ground to the desired diameter. The orientation of the crystal is identified and marked by a notch or a flat. Then the ingot is sawed into wafers, each wafer is scribed by laser with the information of the parent ingot and lapped to eliminate the saw marks in step 930.

Once the ingot is sawed into individual wafers and individually scribed, the wafers are processed as separate entity. Separated process starting from a chemical etch step 940 to remove a damage-layer caused by the lapping operation in step 930. The removing of the damage-layer may be accomplished with a mechanical polishing or with a chemical etching.

Conventionally, for a 200 mm wafer, only the front side of the wafer gets polished at step 950. In some cases, particular for wafers of which the diameter exceeds 200 mm, the back surface of the wafer also gets polished. The double sided polish 945 is generally performed on 300 mm wafers and beyond.

In an embodiment of this invention, a film that enhances the mechanical strength of the wafer is formed on the backside of the wafer before the final polish operation 950.

In this embodiment, the film chosen is silicon carbide. Silicon oxide, silicon nitride may also be used. Other materials that are compatible to integrated circuit device processing may also be used. The silicon carbide film may be formed on the back-side of the wafer with a plasma-enhanced chemical vapor deposition technique in a single wafer process reactor. However, other equipment or deposition process may deposit a film on both sides of the wafer. In such cases, the carbide film on the front side of the wafer must be removed either with a chemical etching process or a mechanical polishing process followed by a thorough surface cleaning.

It is contemplated that the film coating that provide enhancement to the mechanical strength of the wafer must not warp the wafer excessively. With a 200 mm silicon wafer, a silicon carbide film in the range of 0.5 μm to 1.5 μm satisfies this requirement. A more preferable thickness for the silicon carbide film thickness is around 1 μm. For a 300 mm silicon wafer, the silicon carbide film thickness must be reduced in order to preserve the flatness of the wafer and the coated silicon carbide film thickness should be reduced to about 0.5 μm.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A semiconductor starting wafer, comprising
a. a bulk material consisting substantially silicon crystalline material having a polished top surface free of integrated circuit structures and a bottom surface;
b. the bottom surface contacting a non-crystalline silicon-carbide film extending outwardly from the starting wafer; and
c. the non-crystalline silicon carbide film being about 0.5 μm thick.

2. The semiconductor starting wafer in claim 1, in which the diameter of the wafer is about 450 mm.

3. A semiconductor starting wafer, comprising a. a bulk material consisting substantially crystalline material having a polished semiconductor top surface free of integrated circuit structures and a bottom surface;
b. the bottom surface contacting a non-crystalline film extending outwardly from the starting wafer; and
c. the non-crystalline film thickness ranging between 0.5 μm and 3 μm.

4. The semiconductor starting wafer of claim 3, in which the crystalline material comprises silicon.

5. The semiconductor starting wafer of claim 3, in which the crystalline material comprises germanium.

6. The semiconductor starting wafer of claim 3, in which the non-crystalline film comprises silicon and nitrogen.

7. The semiconductor starting wafer of claim 3, in which the non-crystalline film comprises silicon and carbon.

8. The semiconductor starting wafer of claim 3, in which the diameter of the starting wafer is between about 300 mm and 450 mm.

9. A method for forming a semiconductor starting wafer, comprising
a. growing a crystal ingot of silicon material;
b. sawing the ingot into individual silicon wafers having top surfaces and bottom surfaces;
c. removing a layer of silicon material from the top surface and the bottom surface of a wafer;
d. forming a layer of non-crystalline silicon carbide material on the bottom surface of the wafer; and
e. removing the non-crystalline silicon carbide material incidentally formed on the top surface of the wafer.

10. The method of claim 9, in which the diameter of the starting wafer is about 450 mm.

11. The method of claim 9, in which the diameter of the thickness of the silicon carbide material is between 0.1 μm and 0.5 μm.

12. A method for forming a semiconductor starting wafer, comprising
a. growing a ingot of crystalline material;
b. sawing the ingot into individual wafers having top surfaces and bottom surfaces;
c. removing a layer of material from the top surface and the bottom surface of a wafer to remove damaged crystalline material;
d. forming a layer of non-crystalline material on the bottom surface of the wafer; and
e. removing the non-crystalline material incidentally formed on the top surface of the wafer.

13. The method of claim 12, in which the crystalline material comprises silicon.

14. The method of claim 12, in which the crystalline material comprises germanium.

15. The method of claim 12, in which the diameter of the starting wafer is about 300 mm.

16. The method of claim 12, in which the diameter of the starting wafer ranges between about 150 mm and 450 mm.

17. The method of claim 12, in which the non-crystalline material comprises silicon and nitrogen.

18. The method of claim 12, in which the non-crystalline material comprises silicon and carbon.

19. The method of claim 15, in which the thickness of the non-crystalline material is about 1 μm.

20. The semiconductor starting wafer of claim 3, in which the thickness of the bulk crystalline material is between 600 μm and 1200 μm.
